(19) United States
(12) Patent Application Publication
(10) Pub. No.: US 2008/0203176 A1
(43) Pub. Date: Aug. 28, 2008

(54) Printing Medium and Printing Device

(75) Inventor: Reiner Krapf, Reutlingen (DE)

Correspondence Address: MICHAEL J. STRIKER, 103 EAST NECK ROAD, HUNTINGTON, NY, 11743, US

(73) Assignee: ROBERT BOSCH GMBH, STUTTGART (DE)

(21) Appl. No.: 11/997,364

(22) PCT Filed: Nov. 9, 2006
(86) PCT No.: PCT/EP06/68258

§ 371 Date: Jan. 30, 2008

(30) Foreign Application Priority Data
Nov. 14, 2005 (DE) 10-2205-054-130.5

(51) Int. Cl. G06K 19/06

(52) U.S. Cl. 235/494

(57) ABSTRACT

The invention relates to a printing medium for producing a document in order to transmit at least one piece of information. Said printing medium comprises a printing area (12, 38) that is to be printed on as well as a data unit (14) which is used for storing and transmitting the information to an external unit (16). The data unit (14) can be activated remotely by the external unit (16).

### PRIOR ART

The present invention is based on a printing medium for manufacturing a document according to the preamble to claim 1. The present invention also relates to a printing device according to the preamble to claim 9.

DE 101 25 658 A1 has disclosed a business card with an infrared transmission module that can establish a data communication with a receiver device, e.g. a mobile telephone. The business card also has a control element for switching on the infrared transmission module and also has a power supply.

### ADVANTAGES OF THE INVENTION

The present invention is based on a printing medium for manufacturing a document for conveying at least one piece of information, having a printing region provided for being printed and a data unit that is provided for storing and transmitting the information to an external device.

According to the invention, the data unit is provided for being remotely activated by the external device. It is thus possible to eliminate an actuation element for activating the data unit. In particular, this makes it possible to avoid an unintentional activation of the data unit by an inadvertent contact with the document.

In particular, but not exclusively, the present invention relates to such a printing medium for the private manufacture of a document for conveying at least one piece of information. The expression “private manufacture” of a document for conveying a piece of information is understood in particular to mean a manufacture of the document by a user with the aid of a device that is a conventional household appliance; the information relates to the user and/or to a private circle of acquaintances of the user, e.g. relatives or work colleagues. This information can, for example, be the contact information of the user, which can be printed on the printing medium in a conventional fashion, e.g. name, address, job description, telephone number, etc., and/or other information such as appointment details, a personal picture, a resume, etc. The manufacture preferably occurs in the home and/or at the office. In addition, the data unit can be provided for storing multimedia data, which permits information to be conveyed with a high information density. In addition, the external device is preferably an electronic device, e.g. a mobile telephone or a portable computer such as a PDA (personal digital assistant).

The data unit is advantageously provided to draw its operating energy from the external device. It is thus possible to eliminate a power supply, thus saving space and reducing cost. The data unit can advantageously be embodied as an RFID module (radio frequency identification), thus enabling the achievement of an inexpensive printing medium.

Preferably, the printing medium is embodied in the form of a paper product. This allows documents to be manufactured in a particularly inexpensive and simple manner. The paper product can be embodied in the form of paper, cardboard, etc. This advantageously permits the use of printing devices intended for home or office use. The paper product can also be embodied in the form of photo paper, thus making it possible for the data unit to contain, for example, information about a photographic image. Alternatively, the printing medium can be manufactured of plastic. For example, the printing medium can be embodied in the form of a plastic film.

It is also preferable for the data unit to be embedded in the paper product during a manufacturing process. This makes it possible to achieve large printing regions and an advantageous protection of the data unit. Alternatively, the data unit can be glued onto the printing medium during a manufacturing process.

The printing medium is suitably embodied in the form of a card. This makes it possible to achieve formats of the document that are practical and manageable for a user. For example, it is possible to produce a business card, an invitation, a sympathy card, a greeting card, etc.

In another embodiment of the present invention, the printing medium is embodied in the form of a sticker. The data unit can advantageously contain information about an item to which the sticker is applied, making it possible to achieve effective storage systems.

If the data unit is reprogrammable, then an existing document can be used to convey new or updated information.

The data unit can convey the information in clear text by establishing an unencrypted data communication with the external device. It is also possible to achieve an advantageous protection of information stored on the data unit if the data unit is provided for establishing an encrypted data communication with the external device. This can, for example, be achieved through the use of an asymmetric cryptosystem, which provides different keys for encrypting and decrypting a piece of information.

The present invention also proposes a printing device for printing the printing medium according to the invention, which device is provided for programming the data unit. This makes it possible to eliminate the use of an additional write device after a printing of the printing medium. Preferably, the printing device is embodied in the form of a printing device intended for home or office use. Advantageously, the printing device is provided for printing a paper product, e.g. an inkjet printer or laser printer, thus making it possible to achieve an inexpensive manufacture of the document.

If the write device is situated in a print unit, then documents can be manufactured rapidly by writing to the data unit during a printing of the printing region. If the printing device is embodied in the form of an inkjet printer, then the write device can advantageously be situated in a print head.

The present invention also proposes a communication device equipped with a write device, which is provided for programming the data unit. This permits information to be stored in the data unit with a high degree of flexibility. The communication device can, for example, be embodied in the form of a mobile telephone or a portable computer such as a PDA.

### DRAWINGS

Other advantages ensue from the following description of the drawings. Exemplary embodiments of the present invention are shown in the drawings. The drawings, the description, and the claims contain numerous defining characteristics in combination. Those skilled in the art will also suitably consider the defining characteristics individually and unite them into other meaningful combinations.

FIG. 1 shows a portable card for manufacturing a business card, equipped with an RFID module,

FIG. 2 shows a mobile telephone equipped with an RFID reader,

FIG. 3 is a schematic depiction of the RFID reader and the RFID module,

FIG. 4 shows a set of stickers equipped with RFID modules,

FIG. 5 shows an inkjet printer with a print head and a computer,

FIG. 6 shows a print head of the print unit, equipped with an RFID module,

FIG. 7 shows a printing device, an RFID write device, and a computer, and

FIG. 8 shows a mobile telephone equipped with an RFID write device.

### DESCRIPTION OF THE EXEMPLARY EMBODIMENTS

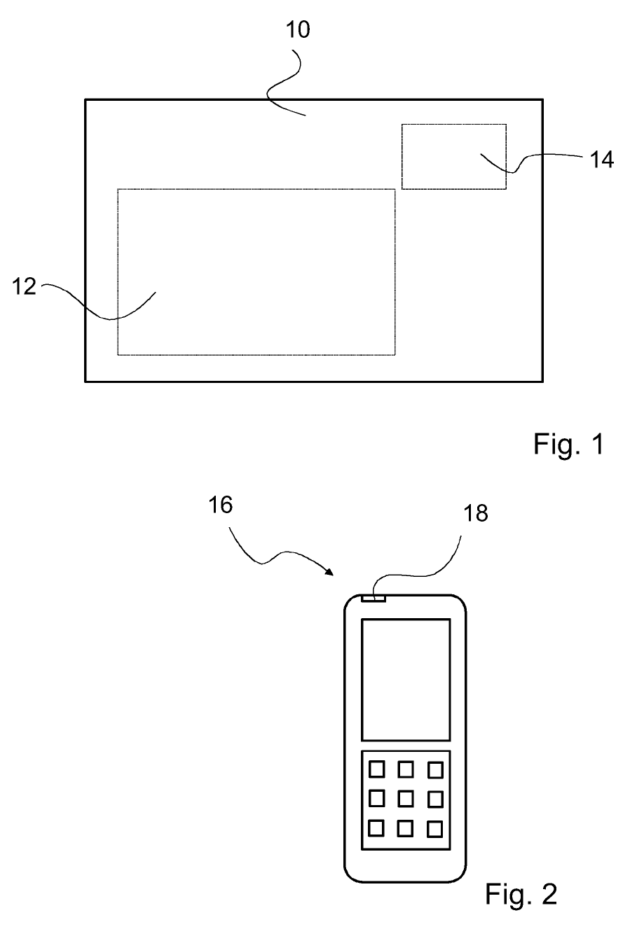

FIG. 1 shows a printing medium embodied in the form of a paper product 10 that is manufactured of cardboard and is card-shaped. It is provided for the manufacture of a business card by a user and for this purpose, has a printing region 12 provided for being printed, which can be labeled with information, in particular contact information of the user such as name, address, telephone number, job description, etc.

The paper product 10 also has a data unit 14 embodied in the form of an RFID module, which is embedded in the paper product 10 during a manufacturing process. The data unit 14 is provided for storing information. In particular, contact information of the user, which is printed, for example, in the printing region 12 during the manufacture of the business card, can be stored in the data unit 14. In addition, the data unit 14 can also contain other information pertaining to the user that is not usually printed on a business card such as appointment details, resume, pictures, etc. The data unit 14 can also transmit information to an external device. This external device can, for example, be a mobile telephone or a portable computer such as a PDA, which belongs to a person with whom the user is speaking. The paper product 10 can also be used to manufacture invitations, sympathy cards, gift cards, greeting cards, postcards, envelopes, etc. and can come in various sizes and surface areas.

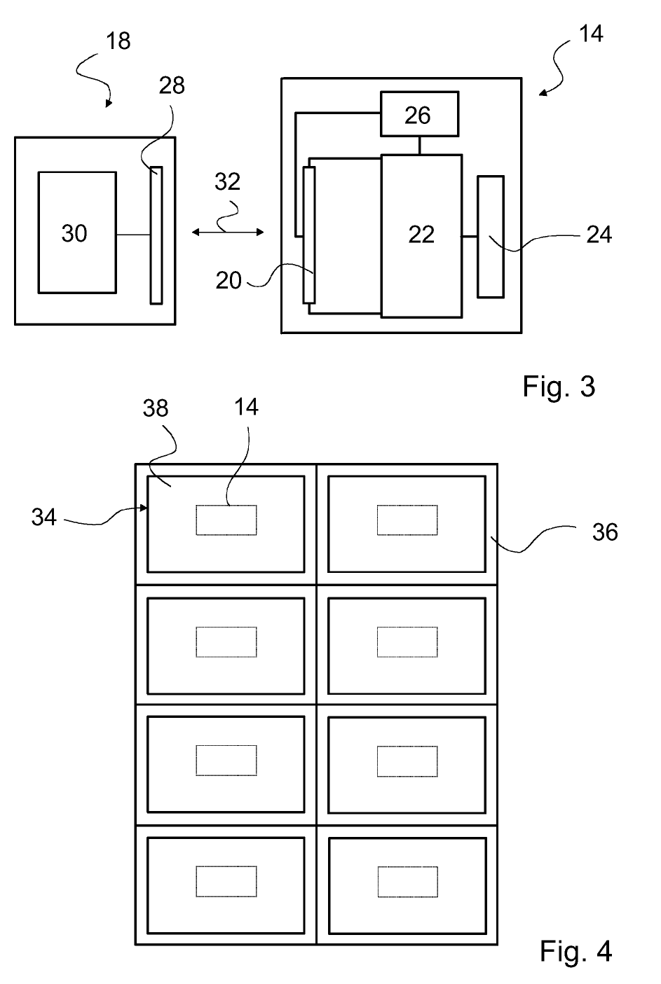

FIG. 2 shows an exemplary embodiment of an external device 16 that comprises a communication device embodied in the form of a mobile telephone. This device has an RFID reader 18 by means of which a data communication can be established with the data unit 14 of the paper product 10. This will be described in greater detail in conjunction with FIG. 3.

FIG. 3 schematically depicts an interior wiring of the data unit 14, which is embodied in the form of an RFID module and belongs to the paper product 10, and also schematically depicts the RFID reader 18 of the external unit 16. The data unit 14 includes an antenna 20, a control unit 22 embodied in the form of a microchip, a memory unit 24 in which the information can be stored, and a capacitor 26. The RFID reader 18 has an antenna 28 and a control unit 30. The data unit 14 is provided for being remotely activated by the external device 16. For this purpose, the RFID reader 18 generates a magnetic or electromagnetic field that is received by the antenna 20. In this antenna 20, induction generates current, which charges the capacitor 26. This operating energy drawn from the external device 16 is stored in the capacitor 26 and supplied for an operation of the control unit 22. With this operating energy, the control unit 22 automatically switches on and attempts to establish a data communication 32 with the RFID reader 18. After the data communication 32 is established, the external device 16 is able to read information stored in the memory unit 24.

It is assumed that the user, when manufacturing a business card—for example in the private manufacture of such a card—has stored his contact information and appointment details, e.g. office hours, in the data unit 14 of the paper product 10 and gives the business card to someone with whom he is speaking. Instead of having to laboriously take down the appointment details, the person with whom he is speaking can store the appointment details in his mobile telephone that is embodied, for example, as the external device 16. For this purpose, he brings the business card into the vicinity of the RFID reader 18 of the mobile telephone, thus establishing the data communication 32. A database of the mobile telephone, e.g. an address book or an appointment calendar is thus automatically updated with the user's contact information and appointment details.

The data unit 14 of the paper product 10 is also provided for establishing an encrypted data communication with the external device 16. For this purpose, an encryption program based on an RSA encryption algorithm is stored in the control unit 22, which is embodied in the form of a microchip. During the manufacture of the business card, a pair of keys—a private key and a public key—is generated and stored in the memory unit 24. The control unit 30 uses the private key to encrypt information stored in the memory unit 24 before this information is transmitted to the external device 16. The private key remains in possession of the user. In order to be able to decrypt this information after receiving it, the external device 16 requires the public key. The user can give this public key to the person with whom he is speaking when handing him the business card. It is thus possible to achieve an advantageous protection of the information, e.g. if a business card of the user is lost and subsequently found by a stranger.

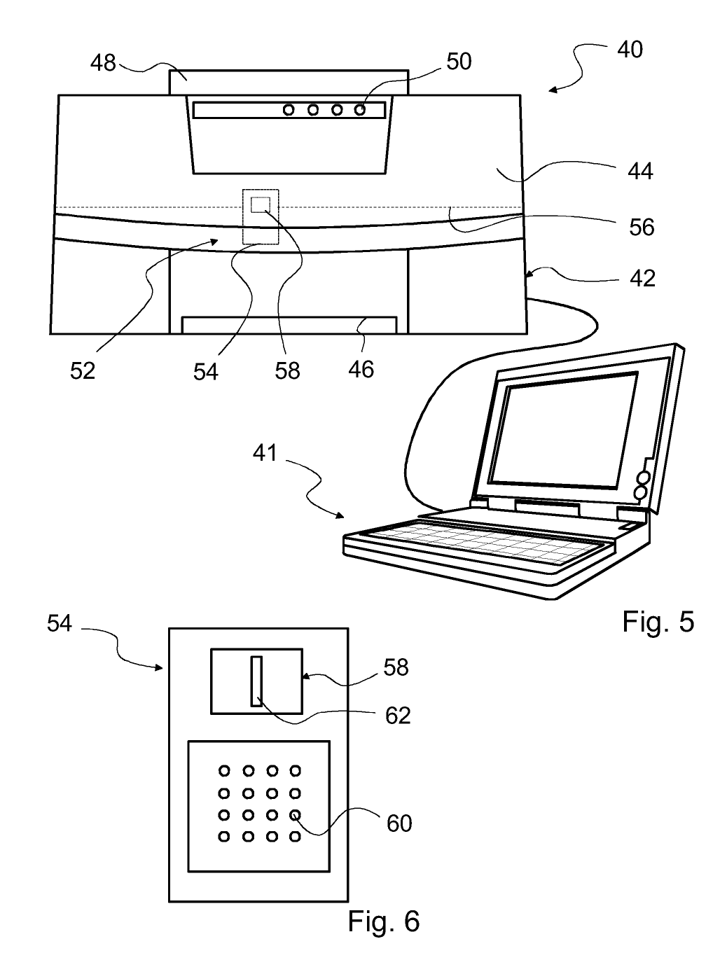

FIG. 4 shows another exemplary embodiment of a printing medium, which is embodied in the form of a sticker 34. The drawing shows a set of stickers 34 glued to a support 36. The stickers 34, which can be detached from the support 36, each have a printing region 38 and are each provided with a data unit 14. This data unit is embedded in the stickers 34 during a manufacturing process. When file folders or records are being filed, the stickers 34 can be used, for example, to manufacture labels on which conventional information such as file numbers or a filing date can be printed; additional information about the contents of a file folder can be stored in the data unit 14. When searching for a particular document or doing research relating to a particular topic, a reader can be used to quickly identify relevant file folders among a large number of file folders by carrying out a search for particular keywords in the data stored in the stickers 34. FIG. 5 shows a printing device embodied in the form of an inkjet printer 40 and a computer 41 connected to this printing device. The printing device has a housing 42 equipped with a flap 44, a lower tray 46 for storing blank paper, an outfeed tray 48, controls 50, and a print unit 52. The design and function of an inkjet printer print unit are known and are not described in detail here. The print unit 52 includes a print head 54, which is situated so that it can move along a rail 56. An RFID write device 58 is situated in the print head 54. FIG. 6 shows one side of the print head 54, which is oriented toward a printing medium during a printing of this printing medium. The drawing shows jets 6, which apply ink to the printing medium, and the RFID write device 58 of which an antenna 62 is shown.

To manufacture a business card or labels, the user can use the computer 51 to generate a text to be printed on the business card or the labels, e.g. with the aid of a conventional word processing program. By means of a special program, which can be installed, for example, as a supplement to the word processing program, the user can enter the information to be stored in the data unit 14. After a start of a printing process, the printing regions 12 and 38 are printed and the corresponding data units 14 are written to. The antenna 62 is provided to transmit a signal in a particular direction with a minimum dispersion. Consequently, the RFID write device 58 of the print head 54 can program the relevant data unit 14 in a position-selective fashion. It is thus possible to prevent the RFID write device 58 from simultaneously activating and programming a plurality of data units 14, e.g. when printing the support 36, which has a plurality of stickers 34 on it. Before the start of the printing process, the software generates a private key and a public key, which are used for encrypting and decrypting the information, and the keys are stored in the memory unit 24 during the programming of the data unit 14. As an alternative to the inkjet printer 40, other printing devices can also conceivably be used, e.g. a laser printer, a thermal transfer printer, etc.

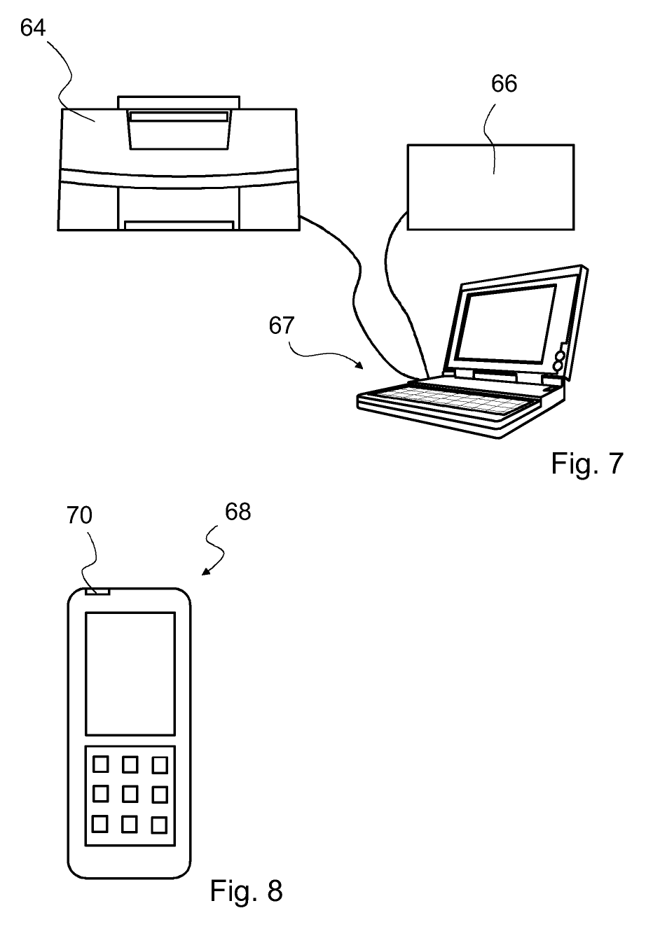

A programming of the data unit 14 can also be carried out with the aid of an external RFID write device after a printing has taken place. FIG. 7 shows a printing device 64 and an RFID write device 66. These devices are connected to a computer 67. After the printing of a printing medium according to the present invention, which is equipped with a data unit 14, the data unit 14 can be programmed with the aid of the external RFID write device 66 and special software of the computer 67. Alternatively, an external RFID write device can be integrated into a communication device. FIG. 8 shows an exemplary embodiment of such a communication device, which is embodied in the form of the mobile telephone 68 and is equipped with an RFID write device 70. When a document that has been manufactured using a printing medium according to the invention, which is equipped with a data unit 14, is brought into the vicinity of the RFID write device 70 of the mobile telephone 68, as described above, a data communication can be established between the RFID write unit 70 and the data unit 14. Using software of the mobile telephone 68, a user can store information in the data unit 14 of the document.

In addition, the data unit 14 is reprogrammable. Data stored in the data unit 14 can be deleted or replaced with other data or other data can be stored in addition to the existing information.

What is claimed is:

1. A printing medium for manufacturing a document for conveying at least one piece of information, having a printing region (12, 38) provided for being printed and having a data unit (14) provided for storing and transmitting the information to an external device (16),
wherein the data unit (14) is provided for being remotely activated by the external device (16).

2. The printing medium as recited in claim 1,
wherein the data unit (14) is provided to draw operating energy from the external device (16).

3. The printing medium as recited in claim 1,
characterized by means of being embodied in the form of a paper product (10).

4. The printing medium as recited in claim 3,
wherein the data unit (14) is embedded in the paper product (10) during a manufacturing process.

5. The printing medium as recited in claim 1,
characterized by means of being embodied in the form of a card.

6. The printing medium as recited in claim 1,
characterized by means of being embodied in the form of stickers (34).

7. The printing medium as recited in claim 1,
wherein the data unit (14) is reprogrammable.

8. The printing medium as recited in claim 1,
wherein the data unit (14) is provided for establishing an encrypted data communication with the external device (16).

9. A printing device for printing a printing medium as recited in claim 1,
characterized by means of a write device (58) that is provided for programming the data unit (14).

10. The printing device as recited in claim 9,
wherein the write device (58) is situated in a print unit (52).

11. A communication device for a printing medium as recited in claim 1, characterized by means of a write device (70) that is provided for programming the data unit (14).
